(19) United States
(12) Patent Application Publication
(10) Pub. No.: US 2020/0396785 A1
(43) Pub. Date: Dec. 17, 2020

(54) Multi-RAT Dual Connectvity

(71) Applicant: Parallel Wireless, Inc., Nashua, NH (US)

(72) Inventor: Yang Cao, Westford, MA (US)

(21) Appl. No.: 16/902,260

(22) Filed: Jun. 15, 2020

Related U.S. Application Data
(60) Provisional application No. 62/861,374, filed on Jun. 14, 2019.

(51) Int. Cl. H04W 76/15

(52) U.S. Cl. CPC H04W 76/15

(57) ABSTRACT

Systems, methods and computer software are disclosed for providing dual connectivity between different Radio Access Technologies (RATs). In one embodiment a method is disclosed, comprising: anchoring a User Equipment (UE) at a first RAT base station in a first RAT core; using a second RAT base station to supplement the first RAT core; and providing dual connectivity between the first RAT and the second RAT.

### CROSS-REFERENCE TO RELATED APPLICATIONS

This application claims priority under 35 U.S.C. § 119(e) to U.S. Provisional Pat. App. No. 62/861,374, filed Jun. 14, 2019, titled “Multi-RAT Dual Connectivity” which is hereby incorporated by reference in its entirety for all purposes. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

3GPP 5G spec contemplates dual connectivity. This is 4G and 5G dual connectivity: UE anchors to 4G core, connects to both 4G RAN and 5G RAN (non-standalone), or, UE anchors to 5G core and connects to both 4G and 5G RAN. Since this is in the 3GPP spec, the UE is able to support DC. Dual connectivity is well-known in the art. For example, see US20180020418A1, hereby incorporated by reference in its entirety. However, Parallel Wireless is in a unique position to enable connectivity in multiple RATs because of its HetNet Gateway. The HetNet Gateway is multi-RAT aware and can hide the complexity of coordinating multiple RATs from each other.

### SUMMARY

Methods, computer readable medium and systems for multi-RAT dual connectivity are described. The HetNet Gateway allows dual connectivity between 2G and 5G; 3G and 5G; 4G and 5G (enhanced with MOCN) and3G and 4G, 2G and 3G, 2G and 4G (interwork one of these to 5G at the base station to enable). Anchor the UE at a 2G/3G/4G core, and use 5G gNB to supplement. HNG's position as a gateway enables local breakout of typical user traffic, so high user throughput is possible even using 2G anchor because most data does not flow through 2G core. In some cases, HNG can connect to both the 5G gNB and the other—RAT nodeB directly and may manage the flow. In other cases, the other—RAT base station may manage data flow. Advantages: increased throughput on downlink; ability for operators to provide staged rollout of 5G gNB.

In one embodiment a method is disclosed providing dual connectivity between different Radio Access Technologies (RATs). The method includes anchoring a User Equipment (UE) at a first RAT base station in a first RAT core; using a second RAT base station to supplement the first RAT core; and providing dual connectivity between the first RAT and the second RAT.

In another embodiment, a non-transitory computer-readable medium contains instructions for providing dual connectivity between different Radio Access Technologies (RATs) which, when executed, causes wireless network devices to perform steps comprising: anchoring a User Equipment (UE) at a first RAT base station in a first RAT core; using a second RAT base station to supplement the first RAT core; and providing dual connectivity between the first RAT and the second RAT.

In another embodiment, a system may be disclosed for providing dual connectivity between different Radio Access Technologies (RATs). The system includes a HetNet gateway (HNG); a first base station in a first RAT in communication with the HNG; a second base station in a second RAT in communication with the HNG and the first base station; a User Equipment (UE) in communication with the first base station and the second base station; wherein the UE is anchored at the first RAT base station in the first RAT core; wherein the second RAT base station supplement the first RAT core; and wherein dual connectivity is provided between the first RAT and the second RAT.

### BRIEF DESCRIPTION OF THE DRAWINGS

FIG. 1 is a network diagram of a prior art Option 3 dual connectivity embodiment.

FIG. 2 is a network diagram of a prior art Option 3A dual connectivity embodiment.

FIG. 3 is a network diagram of a prior art Option 3X dual connectivity embodiment.

FIG. 4 is a network diagram of an Option 3A PW extension dual connectivity embodiment, in accordance with some embodiments.

FIG. 5 is a network diagram of an Option 3A PW 3G extension dual connectivity embodiment, in accordance with some embodiments.

FIG. 6 is a network diagram of an Option 3A PW 2G extension dual connectivity embodiment, in accordance with some embodiments.

FIG. 7 is a diagram of a handover scenario, in accordance with some embodiments.

FIG. 8 is a diagram of a handover scenario changing a 5G Node-B, in accordance with some embodiments.

FIG. 9 is a diagram of a generalized stack showing dual connectivity, in accordance with some embodiments.

FIG. 10 is a schematic network architecture diagram for various radio access technology core networks.

FIG. 11 is a schematic diagram of a coordinating gateway, in accordance with some embodiments.

FIG. 12 is a schematic diagram of an enhanced base station, in accordance with some embodiments.

### DETAILED DESCRIPTION

Dual connectivity as described herein means anchoring on one core network and using throughput from another core network. Can be same RAT (MOCN). Can be anchoring on 2G, 3G, 4G, or 5G. Wi-Fi can be a throughput RAT. Wi-Fi can be an anchoring RAT as well. Can add/aggregate more than one “throughput RAT”. Since HNG hides the complexity from the anchoring core network, enables the use of as many cores and cells as is enabled by the number of radios in the UE.

HNG can operate to virtualize/proxy UE connection to the core. Core can be aware only of anchoring connection for its own RAT. Anchoring base station can be directly enabled to coordinate with supplemental base station or, supplemental base station can be virtualized by HNG to enable the anchoring base station to assume any particular RAT e.g., anchoring base station is LTE, supplemental base station can be interworked to appear to the anchoring base station as a 5G base station even if it is a Wi-Fi RAT AP or a 3G RAT BS e.g., HNG can allow inter-RAT DC for third-party base stations.

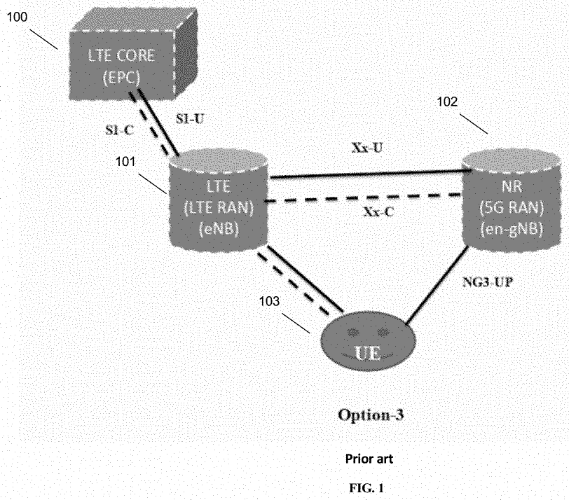

Referring to FIG. 1, a system is shown including an LTE core 100, an eNB 101, a gNB 102 and a UE 103. In FIG. 1, in the plain option 3, all uplink/downlink data flows to and from the LTE 100 part of the LTE/NR base station, i.e, to and from the eNB 101. The eNB then decides which part of the data it wants to forward to the 5G gNB part 102 of the base station over the Xx interface. In simple terms, the 5G gNB never communicates with the 4G core network directly.

Salient features: UE 103 is be connected to both 5G NR and 4G LTE. For Option 3 Control Plane relies on EPS LTE S1 MME interface and LTE RRC Control. For Option 3 User Plane might split bearer.

Key advantages: Reuse of EPC & S1, low investment (only for 5G BS gNB), possible reuse of VoLTE with minor upgrade.

Up gradations required: increased complexity in 5G UEs (EN-DC capable), upgrade to eNB to connect to gNB via Xx/Xn interfaces. Backhaul requirements of 5-30 ms between gNB and eNB.

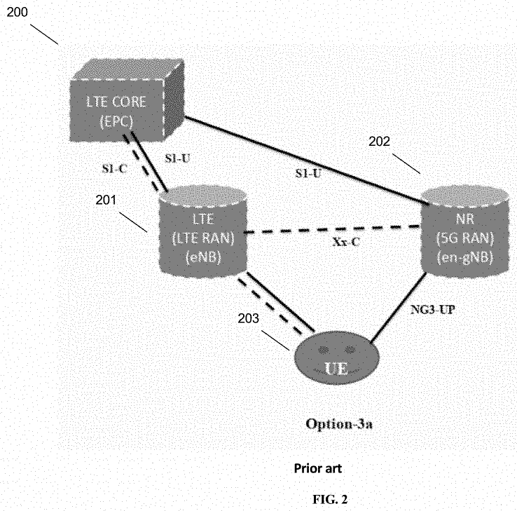

Referring to FIG. 2, a system is shown including an LTE core 200, an eNB 201, a gNB 202 and a UE 203. In this option, both the LTE eNB 201 and the 5G gNB 202 can directly talk to the EPS core network but they cannot directly talk with each other over the Xx (X2) interface. This means that a single databearer cannot share the load over LTE and NR. For example, VoLTE voice traffic for a user is handled by LTE while his Internet traffic is handled by the 5G part of the base station. It would be difficult to implement this scenario if the devices keep moving in and out of 5G network coverage continuously.

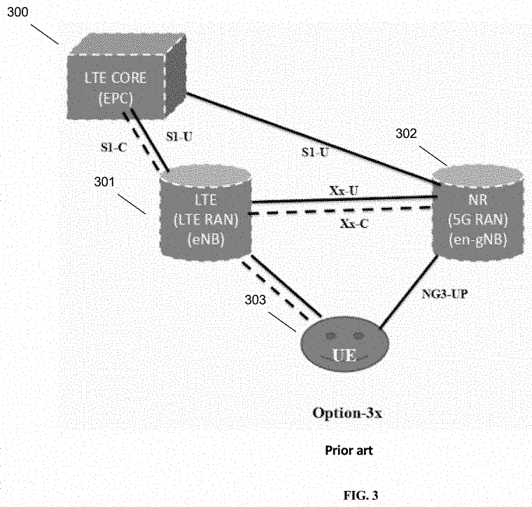

Referring to FIG. 3, a system is shown including an LTE core 300, an eNB 301, a gNB 302 and a UE 303. FIG. 3, option 3X is a combination of 3 and 3A. In this configuration, user data traffic will flow directly to the SG gNB part of the base station. From there, it is delivered over the air to the mobile device. A part of the data can also be forwarded over the X2 interface to the 4G eNB part of the base station and from there to the UE. Slow data streams (Low Data). E.g. VoLTE bearers with a different IP address than that used for Internet access can be directly delivered from the core network to the 4G eNB part of the 4G/5G base station. The advantage is that the 5G upgrade of the base station is likely to have the much better performing IP interface so it is better suited to handle the higher data rates that can only be reached with a 4G/5G non-Standalone network deployment.

Option-3x provides robust coverage in higher frequencies and aggregated peak bit rate of LTE and 5G for lower frequencies. Option-3X also provides near zero interrupt time LTE-5G mobility. Option-3X provides voice in LTE without using RAT fallback. This configuration can be used in scenarios where LTE coverage reach is superior to that of NR and thus leverages EPC.

In this configuration, the LTE eNB will act as the Master and will have control over which S1-U bearers are handled by radio of LTE or NR. Based on instructions from LTE eNB, MME will inform S-GW where to establish S1-U bearers, i.e. LTE or N R. If NR radio quality falls below a certain threshold, S1-U bearer towards NR may be either split at NR and sent entirely over Xx to LTE or a PATH SWITCH may be triggered where all 51-U will go to LTE eNB. \

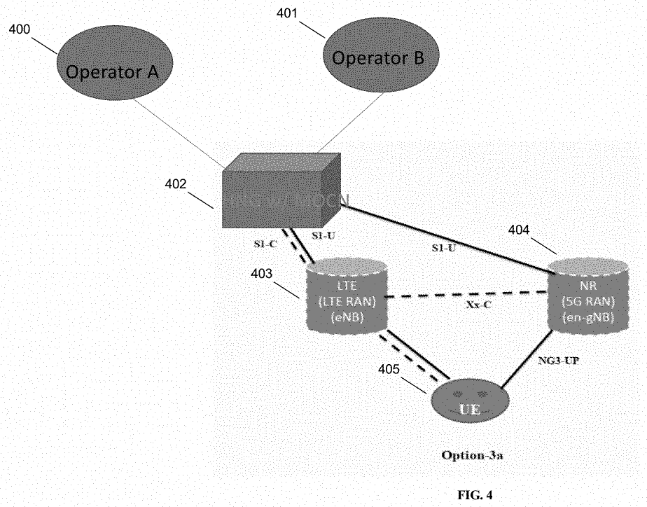

Referring to FIG. 4, a system is shown including a first operator 400 and a second operator 401, an HNG 402, an eNB 403, a gNB 404 and a UE 405. The MOCN support allows two operator networks to be combined to provide additional throughput to a UE anchored on one of the networks, even when the LTE RAN is on Operator A and the 5G RAN is on Operator B.

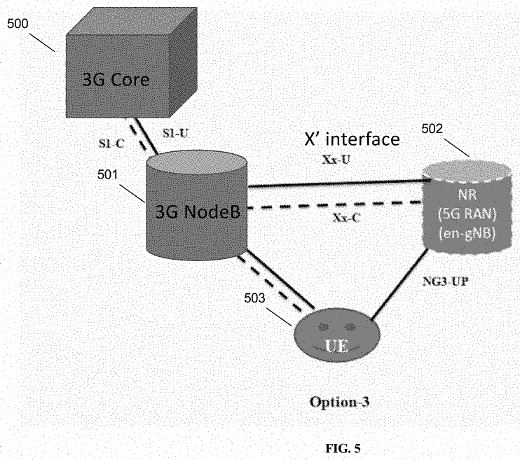

Referring to FIG. 5, a system is shown including a 3G core 500, a 3G NodeB 501, a gNB 502 and a UE 503. The 3G nodeB is enabled to use DC with a 5G NR RAN, as long as it is supported by the UE. 3G Flat architecture: an architecture in which the 3G core is simplified to eliminate the RNC. The RNC is integrated into the base station. The 3G Flat nodeB is extended to provide all the DC functionality described.

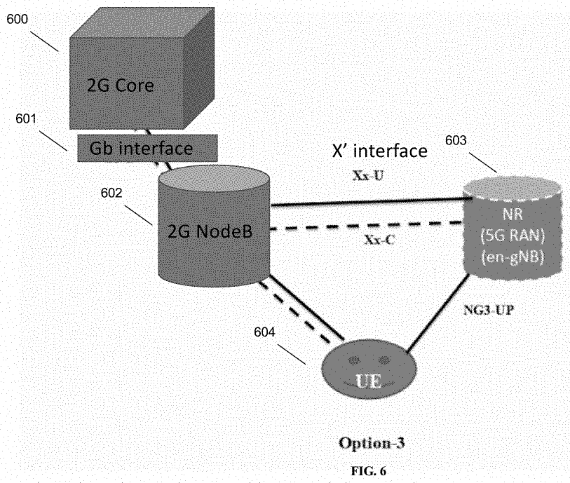

Referring to FIG. 6, a system is shown including a 2G core 600, a Gb interface 601, a 2G NodeB 201, a gNB 603 and a UE 604. This 2G embodiment is similar to the 3G embodiment, with a Gb interface bridge between an enhanced NodeB and the 2G Core. The Gb interface bridge provides interworking to enable messages from the 2G nodeB, 5G RAN, and the UE to be properly anchored at the 2G core.

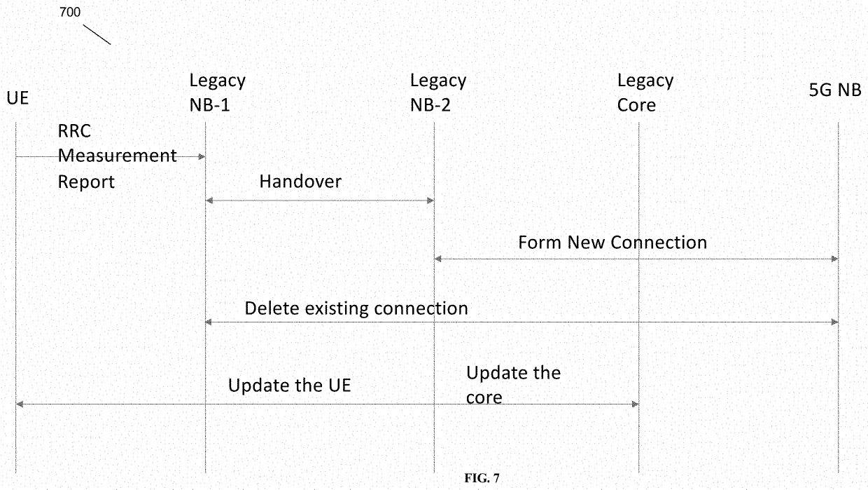

FIG. 7 shows the communications 700 for a first handover scenario changing Anchor Node-B. The UE is able to handover from legacy nodeB 1 to legacy nodeB 2, with the legacy nodeB 2 forming a new connection with, and the legacy nodeB 1 deleting its existing connection via, the 5G nodeB. The 5G core is able to interwork with the legacy core, using the various architectures shown above. Anchoring is performed at the legacy core. Handover may be based on any well-known handover procedure or trigger, including an RRC measurement report from the UE.

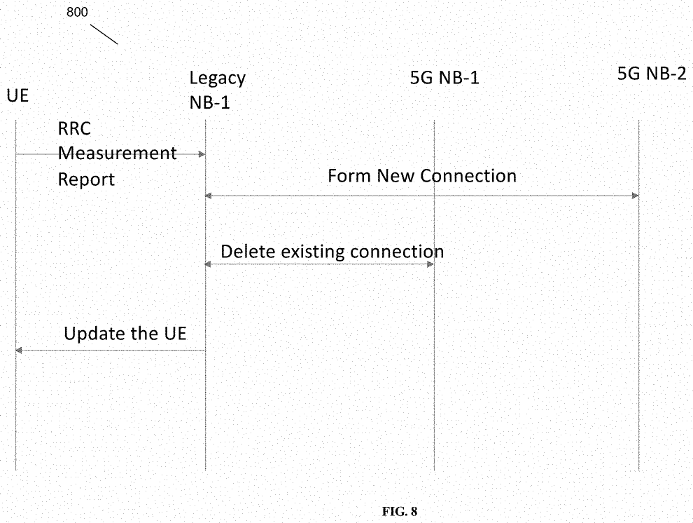

FIG. 8 shows the communications 800 for a second handover scenario—changing 5G Node-B. From the legacy nodeB, a new connection is formed to the new 5G nodeB 2. The new connection is in this embodiment invisible to the legacy core. Make before break ensures minimal impact to traffic delivery.

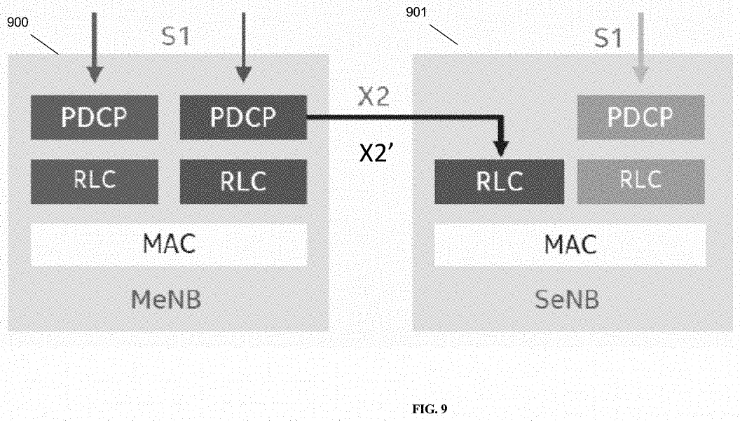

FIG. 9 shows a Dual Connectivity—Generalized Stack View for an MeNB 900 and a SeNB 901. The MeNB is coupled via a modified X2′ interface between the PDCP of the MeNB and the RLC of the SeNB. Where eNodeB is written here and throughout, it is understood that any RAT node B is meant to be understood and could be used with proper interworking. This method could be used to provide transparent DC and handover with attach to a legacy core of any RAT, with DC of any two (or more) RATs.

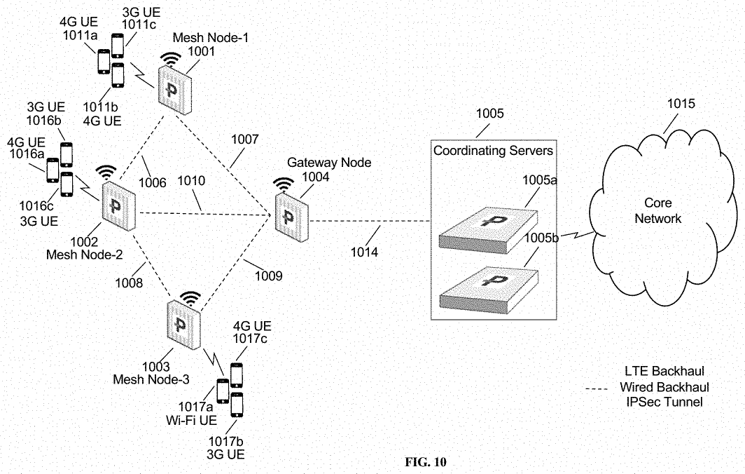

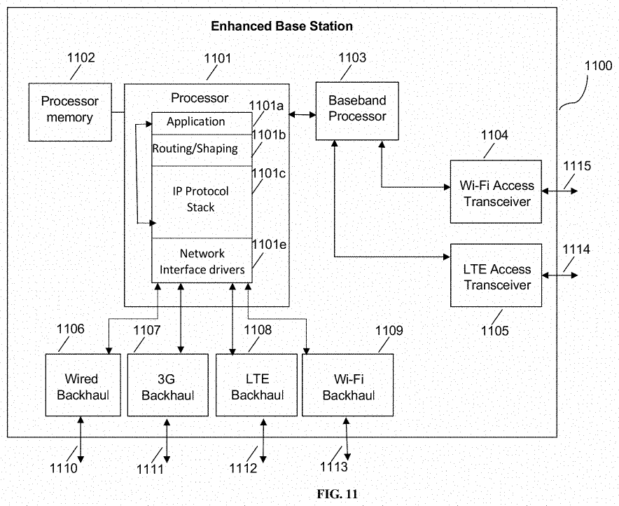

FIG. 10 is a network diagram in accordance with some embodiments. In some embodiments, as shown in FIG. 11, a mesh node 1 1001, a mesh node 2 1002, and a mesh node 3 1003 are any-G RAN nodes. Base stations 1001, 1002, and 1003 form a mesh network establishing mesh network links 1006, 1007, 1008, 1009, and 1010 with a base station 1004. The mesh network aspect of FIG. 10 is optional and does not need to be present in all embodiments of the present disclosure. The mesh network links are wireless backhaul links that can be used by the mesh nodes to route traffic around congestion within the mesh network as needed. The base station 1004 acts as gateway node or mesh gateway node, and provides backhaul connectivity to a core network to the base stations 1001, 1002, and 1003 over backhaul link 1014 (which may be wired or wireless) to a coordinating server(s) 1005 and towards core network 1015. The Base stations 1001, 1002, 1003, 1004 may also provide eNodeB, NodeB, Wi-Fi Access Point, Femto Base Station etc. functionality, and may support radio access technologies such as 2G, 3G, 4G, 5G, Wi-Fi etc. The base stations 1001, 1002, 1003 may also be known as mesh network nodes 1001, 1002, 1003.

Coordinating server 1005 includes failover servers 1005a and 1005b. Coordinating server 1005 is the virtualization gateway described in the present disclosure, and is present between the RAN and the core network. Core network 1015 may be one or more core networks; may be of any RAT, including 2G/3G/4G/5G NSA/5G SA.

The coordinating servers 1005 are shown as two coordinating servers 1005a and 1005b. The coordinating servers 1005a and 1005b may be in load-sharing mode or may be in active-standby mode for high availability. The coordinating servers 1005 may be located between a radio access network (RAN) and the core network and may appear as core network to the base stations in a radio access network (RAN) and a single eNodeB to the core network, i.e., may provide virtualization of the base stations towards the core network. As shown in FIG. 10, various user equipments 1011a, 1011b, 1011c are connected to the base station 1001. The base station 1001 provides backhaul connectivity to the user equipments 1011a, 1011b, and 1011c connected to it over mesh network links 1006, 1007, 1008, 1009, 1010 and 1014. The user equipments may be mobile devices, mobile phones, personal digital assistant (PDA), tablet, laptop etc. The base station 1002 provides backhaul connection to user equipments 1012a, 1012b, 1012c and the base station 1003 provides backhaul connection to user equipments 1013a, 1013b, and 1013c. The user equipments 1011a, 1011b, 1011c, 1012a, 1012b, 1012c, 1013a, 1013b, 1013c may support any radio access technology such as 2G, 3G, 4G, 5G, Wi-Fi, WiMAX, LTE, LTE-Advanced etc. supported by the mesh network base stations, and may interwork these technologies to IP.

FIG. 11 is an enhanced eNodeB for performing the methods described herein, in accordance with some embodiments. Mesh network node 1100 may include processor 1102, processor memory 1104 in communication with the processor, baseband processor 1106, and baseband processor memory 1108 in communication with the baseband processor. Mesh network node 1100 may also include first radio transceiver 1112 and second radio transceiver 1114, internal universal serial bus (USB) port 1116, and subscriber information module card (SIM card) 1118 coupled to USB port 1116. In some embodiments, the second radio transceiver 1114 itself may be coupled to USB port 1116, and communications from the baseband processor may be passed through USB port 1116. The second radio transceiver may be used for wirelessly backhauling eNodeB 1100.

Processor 1102 and baseband processor 1106 are in communication with one another. Processor 1102 may perform routing functions, and may determine if/when a switch in network configuration is needed. Baseband processor 1106 may generate and receive radio signals for both radio transceivers 1112 and 1114, based on instructions from processor 1102. In some embodiments, processors 1102 and 1106 may be on the same physical logic board. In other embodiments, they may be on separate logic boards.

Processor 1102 may identify the appropriate network configuration, and may perform routing of packets from one network interface to another accordingly. Processor 1102 may use memory 1104, in particular to store a routing table to be used for routing packets. Baseband processor 1106 may perform operations to generate the radio frequency signals for transmission or retransmission by both transceivers 1110 and 1112. Baseband processor 1106 may also perform operations to decode signals received by transceivers 1112 and 1114. Baseband processor 1106 may use memory 1108 to perform these tasks.

The first radio transceiver 1112 may be a radio transceiver capable of providing LTE eNodeB functionality, and may be capable of higher power and multi-channel OFDMA. The second radio transceiver 1114 may be a radio transceiver capable of providing LTE UE functionality. Both transceivers 1112 and 1114 may be capable of receiving and transmitting on one or more LTE bands. In some embodiments, either or both of transceivers 1112 and 1114 may be capable of providing both LTE eNodeB and LTE UE functionality. Transceiver 1112 may be coupled to processor 1102 via a Peripheral Component Interconnect-Express (PCI-E) bus, and/or via a daughtercard. As transceiver 1114 is for providing LTE UE functionality, in effect emulating a user equipment, it may be connected via the same or different PCI-E bus, or by a USB bus, and may also be coupled to SIM card 1118. First transceiver 1112 may be coupled to first radio frequency (RF) chain (filter, amplifier, antenna) 1122, and second transceiver 1114 may be coupled to second RF chain (filter, amplifier, antenna) 1124.

SIM card 1118 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 1100 is not an ordinary UE but instead is a special UE for providing backhaul to device 1100.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 1112 and 1114, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 1102 for reconfiguration.

A GPS module 1130 may also be included, and may be in communication with a GPS antenna 1132 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 1132 may also be present and may run on processor 1102 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

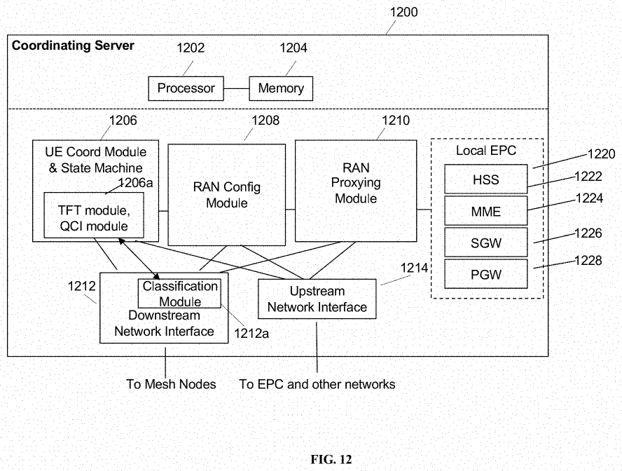

FIG. 12 is a coordinating server for providing services and performing methods as described herein, in accordance with some embodiments. Coordinating server 1200 includes processor 1202 and memory 1204, which are configured to provide the functions described herein. Also present are radio access network coordination/routing (RAN Coordination and routing) module 1206, including ANR module 1206a, RAN configuration module 1208, and RAN proxying module 1210. The ANR module 1206a may perform the ANR tracking, PCI disambiguation, ECGI requesting, and GPS coalescing and tracking as described herein, in coordination with RAN coordination module 1206 (e.g., for requesting ECGIs, etc.). In some embodiments, coordinating server 1200 may coordinate multiple RANs using coordination module 1206. In some embodiments, coordination server may also provide proxying, routing virtualization and RAN virtualization, via modules 1210 and 1208. In some embodiments, a downstream network interface 1212 is provided for interfacing with the RANs, which may be a radio interface (e.g., LTE), and an upstream network interface 1214 is provided for interfacing with the core network, which may be either a radio interface (e.g., LTE) or a wired interface (e.g., Ethernet).

Coordinator 1200 includes local evolved packet core (EPC) module 1220, for authenticating users, storing and caching priority profile information, and performing other EPC-dependent functions when no backhaul link is available. Local EPC 1220 may include local HSS 1222, local MME 1224, local SGW 1226, and local PGW 1228, as well as other modules. Local EPC 1220 may incorporate these modules as software modules, processes, or containers. Local EPC 1220 may alternatively incorporate these modules as a small number of monolithic software processes. Modules 1206, 1208, 1210 and local EPC 1220 may each run on processor 1202 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the above systems and methods are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for providing dual connectivity between different Radio Access Technologies (RATs), comprising:
anchoring a User Equipment (UE) at a first RAT base station in a first RAT core;
using a second RAT base station to supplement the first RAT core; and
providing dual connectivity between the first RAT and the second RAT.

2. The method of claim 1 wherein anchoring a UE at a first RAT core includes anchoring the UE at one of a 2G core, 3G core or a 4G core, and wherein the second RAT base station is a 5G gNB.

3. The method of claim 2 wherein anchoring the UE at a 4G core is enhanced using MOCN.

4. The method of claim 1 further comprising enabling local breakout of typical user traffic.

5. The method of claim 1 wherein the first RAT is 3G and the second RAT is 4G.

6. The method of claim 1 wherein the first RAT is 2G and the second RAT is 3G or 5G.

7. A non-transitory computer-readable medium containing instructions for providing dual connectivity between different Radio Access Technologies (RATs) which, when executed, causes wireless network devices to perform steps comprising:
anchoring a User Equipment (UE) at a first RAT base station in a first RAT core;
using a second RAT base station to supplement the first RAT core; and
providing dual connectivity between the first RAT and the second RAT.

8. The computer-readable medium of claim 7 further comprising instructions wherein anchoring a UE at a first RAT core includes anchoring the UE at one of a 2G core, 3G core or a 4G core, and wherein the second RAT base station is a 5G gNB.

9. The computer-readable medium of claim 8 further comprising instructions wherein anchoring the UE at a 4G core is enhanced using MOCN.

10. The computer-readable medium of claim 7 further comprising instructions for enabling local breakout of typical user traffic.

11. The computer-readable medium of claim 7 further comprising instructions wherein the first RAT is 3G and the second RAT is 4G.

12. The computer-readable medium of claim 7 further comprising instructions for wherein the first RAT is 2G and the second RAT is 3G or 5G.

13. A system for providing dual connectivity between different Radio Access Technologies (RATs), comprising:
a HetNet gateway (HNG);
a first base station in a first RAT in communication with the HNG;
a second base station in a second RAT in communication with the HNG and the first base station;
a User Equipment (UE) in communication with the first base station and the second base station;
wherein the UE is anchored at the first RAT base station in the first RAT core;
wherein the second RAT base station supplement the first RAT core; and
wherein dual connectivity is provided between the first RAT and the second RAT.

14. The system of claim 13 wherein the UE is anchored at one of a 2G core, 3G core or a 4G core, and wherein the second RAT base station is a 5G gNB.

15. The system of claim 14 wherein the UE is anchored at a 4G core and is enhanced using MOCN.

16. The system of claim 13 wherein local breakout of typical user traffic is provided.

17. The system of claim 13 wherein the first RAT is 3G and the second RAT is 4G.

18. The system of claim 13 r wherein the first RAT is 2G and the second RAT is 3G or 5G.
